(19) United States
(12) Patent Application Publication
(10) Pub. No.: US 2018/0289169 A1
(43) Pub. Date: Oct. 11, 2018

(54) Multi-Functional Heater for Warming Bed Covers

(71) Applicants: Le Le, Puyyallup, WA (US); Racheal Bratsch, Puyyallup, WA (US)

(72) Inventors: Le Le, Puyyallup, WA (US); Racheal Bratsch, Puyyallup, WA (US)

(21) Appl. No.: 15/949,050

(22) Filed: Apr. 9, 2018

Related U.S. Application Data
(60) Provisional application No. 62/483,414, filed on Apr. 9, 2017.

(51) Int. Cl. A47C 21/04; H05B 1/02; A47C 31/00

(52) U.S. Cl. CPC A47C 21/044; H05B 1/0272; H05B 1/0297; H05B 2203/036; A47C 31/005; A47C 21/048; A47C 31/008

(57) ABSTRACT

A multifunctional heater that blows warmed/cooled air for a variety of usages primarily in the bedroom. The warm/cool air is blown through several accessories, including a body blanket warmer, stuffed animal warmers, foot panel warmers, knee wedge warmers as well as a universal warmer container for warming body pillows, knee wedges, towels and other items. The multifunctional heater is useful in distributing different heat levels to each person sleeping in the bed, providing optimal comfort for each person in the bed. The device also comes with an aromatherapy unit to distribute aromas through the night to facilitate sleeping.

### FIELD OF THE INVENTION

A bed warmer that provides people, that desire different temperatures, a comfortable for each person sleeping in the same bed, as well as providing sufficient warmth for elderly or sick people.

### PRIOR RELEVANT PATENTS

| | | Issue or | |
|---|---|---|---|
| Patent # | Kind | Application | |
| Publication # | Code | Date | Inventee(s) |
| U.S. Pat. No. 4,455,472 | A | Jan. 12, 1981 | Arlon R. Moss |
| U.S. Pat. No. 2,452,234 | A | Oct. 26, 1948 | John C. Gerdes |
| U.S. Pat. No. 2,565,390 | A | Aug. 21, 1951 | David Mintosky |
| US20070272673 | A1 | Oct. 3, 2006 | Barry Keane |
| US20150189995 | A1 | Mar. 23, 2015 | Harold P. Mintz |
| US20120273475 | A1 | Sep. 21, 2011 | Jung Ho An |
| US20100038354 | A1 | Mar. 14, 2008 | Aldo Stabile |
| U.S. Pat. No. 9,463,124 | B2 | Oct. 11, 2016 | Charles A. |
| | | | Lachenbruch |
| | | | Rachel L. Williamson |
| | | | Katherine M. |
| | | | McDonnell |

### DISCUSSION OF RELEVANT PATENTS

There are a variety of methods covered in these patents to warm the bed under the covers, none of them warm one side of the bed warmer than the other

CN 200620084519 uses magnetic fields to warm the bed.

U.S. Pat. No. 4,455,472A uses two spaced, perforated, non-metallic plates between which there is arranged spaced loops of an insulated cover-type resistance heating fuse wire. At least some side area between the plates is open allowing lateral movement of air to prevent overheating. The plates are under a thin overlay to prevent burning.

U.S. Pat. No. 2,452,234A is a heating system with air that is suspended under the bed. It requires a thin mattress and box spring to be effective.

U.S. Pat. No. 2,565,390A discloses an electric mattress and an electric mattress pad and other such spreads. The invention preferably includes a regulator system wherein the current supplied to the heating element of the mattress or mattress pad is a function of the resistance associated with the heating elements.

US 20150189995A1 is a bed top covering including a back-folded, electrically heated, foot canopy therein configured to allow the feet of a user to be extended in an upward direction to warm the feet.

US 20120273475A1 discloses automatic mattress heating apparatus which automatically heats a mattress selectively or completely. The heating apparatus automatically heats a part or the entirety of a heated area of a mattress according to the number of sleeping persons or the positions of the sleeping persons.

US 20100038354A1 uses layers of laminar electricity conducting elements to heat the top of the bed covers uniformly.

U.S. Pat. No. 9,463,124B2 is a system based on air flow. This is a microclimate system includes a topper and an air box. The topper is configured to conduct air along a surface of the topper so that heat and moisture from a patient lying on the topper are drawn away from the surface. The air box includes a blower coupled to the topper to provide air to the topper to be conducted along the surface of the topper.

### SUMMARY OF INVENTION

People sleeping in the same bed frequently prefer different temperatures. While there are devices, as described in the prior art above, that warms the whole bed uniformly none of them address the need for different temperatures on different sides of the bed. The device disclosed in this application offers a solution to the technical problem of heating each side of the bed to a different temperature with a simple, easy to use device to heat each side of the bed to a different temperature. This done with air flow over a heating element that is flowed through two tubes one to each side of the bed, the tubes positioned in a knee wedge or similar device. The air flow and temperature for each side are controlled by a controller on the heating element and air pumps casing, and one or two hand held controller(s) that are placed near the head of the bed.

Other than blowing air under the covers, other applications are having the main heater unit blow warm/cold air to the inside of canopy through an air tube/hose. Some examples of this application would include canopies for adult beds, kid beds, and baby cribs. Another application could be having the main heater unit will blow warm/cold air through the ventilation holes on the flooring of the pet housing. A third alternative application is blowing warm/cold air through a bed skirt, a bed skirt is an accessory that goes around the bottom of the bottom mattress or the bed frame, when it has ventilation holes. Direction of the air flow will point toward the bodies in the bed, Coverings may go on top of the bed skirt to trap the air in when warm/cold air is not blowing in.

### DETAILED DESCRIPTION

The multifunctional heater has been created to offer warm/cold air for a variety of usages. Some of the uses of the multifunctional heater are:
1. To offer people sleeping with one another the ability to have the bed at the desired temperatures by blowing warm/cold air into an area under the blanket.
2. To warm up objects such as towels, body pillows, knew wedges, socks clothing and pillow pets.
3. To warm up a blanket on the bed that has holes along each side of the blanket, with each side of the blanket being able to adjust to a different temperature.
4. To have a foot warmer, which is also temperature adjusted by the use of warm/cold air.
5. To add heat to knee wedge type devices, which are long round tubes, through the use of air through knee wedge covers. Knee wedges themselves are not part of the invention, but the ability to warm the wedges through covers or another device.
6. Other possible variations are to blow warm air through a stuffed animal accessory which has air vents, or through body pillows.
7. The multifunctional heater can also be used as a space heater, blowing warm air throughout the room.

Some of the important features of the multifunctional heater are:
1. The multifunctional heater casing includes, but is not limited to:
   the heating element, which could be a resistance heater, a heated fluid, or other heating device;
   the air pumps or fans to move the air;
   a thermostat;
   a temperature reading device;
   a mother board controller, which may be controlled remotely either by a cell phone or a remote control;
   the motherboard also automatically controls the functions of the multifunctional heater controls the functions of the multifunctional heater such as;
      regulating the temperature of the air, opening and closing the mechanical parts for the holes,
      regulating how much air is being pushed through hoses
      auto-timer on/off
      controls the LED lights (decorative or night lights)
      allow connections of smart apps
   emergency shut on the casing;
   emergency shut off via cell phone or remote control;
   timer;
   display panel;
   on/off switch;
   glass element on the top to hold aromatherapy oils that will vaporized as the heater generates heat;
   ventilation holes to bring in air when the fans are turned on;
2. Accessories that can included the heater, including but limited to:
   Foot warmer panels that has slats that can move in and out to form an arch and also have the ability to lock in place Multiple holes in the foot panels allow warm air to flow from the foot warmer panel under the covers.
   A large universal warming chamber, a second compartment of the invention, but separate from the multifunctional heater, that is connected via hoses and that can warm pillows, knee-wedges, socks, clothing items, towels.
   A knee wedges warming system based on warm air flow in a cover
   Body blanket warmer that has a special design side that has holes to distribute air throughout the blanket. The side of the blanket with air flow will be on the side of the blanket nearest the sleeping person user. The body blanket can have different temperature on each side of the bed.
   A stuffed animal accessory.
   Body pillow accessory

Hoses run from the multifunctional heater casing to all of the accessories through easy connection methods such as latches, magnetic, connections clips and snaps on connections.

### BRIEF DESCRIPTION OF DRAWINGS

1. Side view of the multifunctional heater
2. Top view of the multifunctional heater
3. Blanket warming accessory
4. Stuffed animal warming accessory
5. Warming box
6. Foot warmer accessory with the air flow raising the fabric air chamber to a high position
7. Foot warmer accessory with the air flow raising the fabric air chamber to a lower position
8. Knee wedge warmer accessory
9. Body pillow warmer accessory

### NUMBERING DESCRIPTION ON THE DRAWINGS

1. Power cord
2. Battery/AC-DC power module
3. Microprocessor/microcontroller/WIFi nodule
4. Air chamber floor
5. Heater Module
6. Sliding gates for temperature control
7. Fans, operable individually or separately
8, Servo motor for vent control
9. Aromatherapy module
10. Aromatherapy vent with microcontroller
11. Vents
12, LED Lighting
13. Accessory hoses
14. Accessory hose connection point, (magnet, valve or other)
15. Outer rotating vent control
16. Inner rotating vent control
17. Ventilation holes
18. HEPA Air Filter Module
19. Vent for Vans
20. Blanket
21, Blanket closing strip (magnets, Velcro or other closing mechanism
22. Other blanket closing strip (embedded magnets or straps or other)
23. Holes/mesh/vents for air output
24. Stuffed animal
25. Power supply (battery or other for LEDs)
26, Led accent night lights
27. Bluetooth or WIN module for LED control
28, Container for towel/clothes
79. Blanket cover for foot warmer
30. Memory foam or other pad
31. Fabric air chamber
32. 360 degree rotatable vents
33. Sliding slats for warmer curvation
34. Air distribution pipeline for fabric air chamber
35. Body pillow/knee wedge
36. Air release valve

### DETAILED DESCRIPTION OF THE DRAWINGS

In the summary of the invention above and in the Detailed Description of the invention below, and in the accompanying drawings, reference is made to particular features of the invention, is understood that the disclosure of the invention in this specification includes all possible combinations of such particular features.

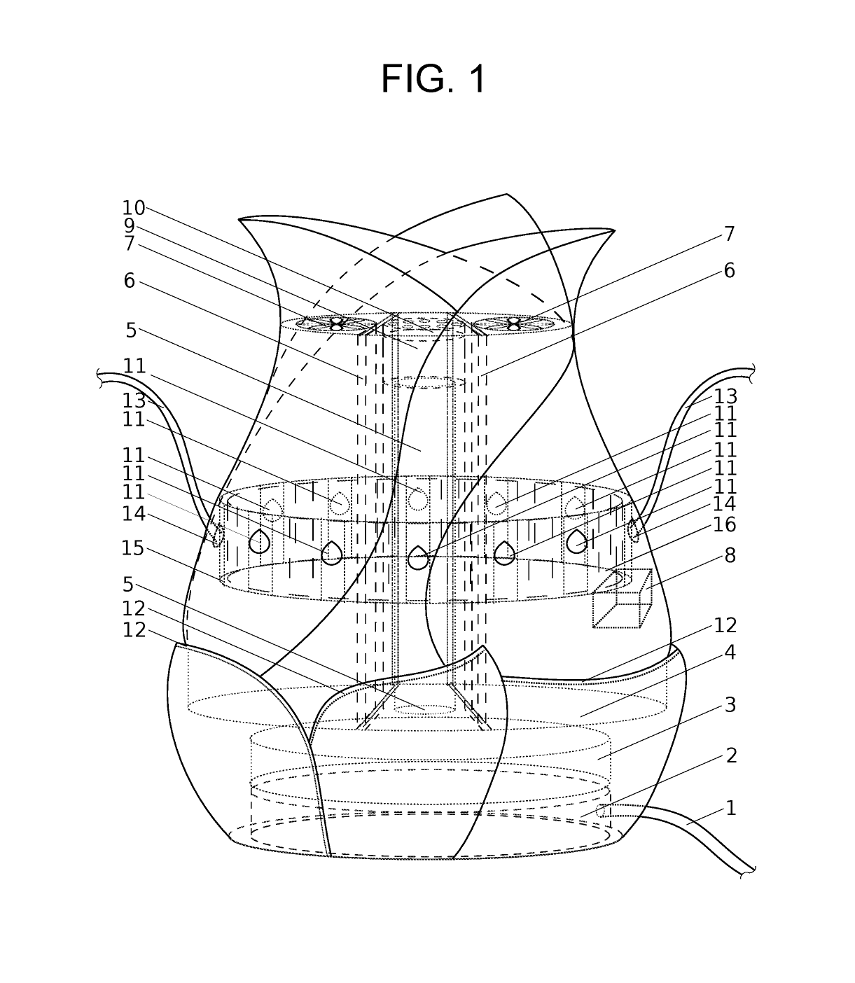

FIG. 1 shows a side view of the multifunctional heater according to one non-limiting embodiment of the present invention. From the bottom of the device the power cord 1 send power to the battery/ACDC power module 2 either recharging the battery or powering the unit with ACDC power. On top of the battery/ACDC power module sits the microprocessor/microcontroller/WIFi module 3 which allows for the unit to be operated by remote control or through an app on a cell phone. The air chamber floor 4 isolates the battery/ACDC power module 2 and the microprocessor/WIFI module 3 from the rest of the unit. The large ventilation holes 17 (6 total) are present to allow air into the unit from fan 7 operation to ensure adequate air flow. A HEPA air filter 18 takes the air flow before going to the accessory hose. LED lighting 12 follow the artistic pattern on the bottom of the device. The lighting allows the device to be observed at night. The heater module 5 runs from near the top of the unit to the base and is connected (not shown) to the battery/ACDC power module 2. The outer rotating vent control 15 and Inner rotating vent control 16 work together through the servo motor for vent control 8 which is connected (not shown) to battery/ACDC power module 2 to determine which vent holes 11 are connected to an accessory hose 13 through an accessory hose connection point 14. Sliding gates for temperature control 6 allow more or less air into the heater module and are represented by the dashed lines on the drawing. Near the top of the device an aromatherapy module 9 and an aromatherapy vent with microcontroller 10 the two coordinate with the heater module 5 to allow aromatherapy oils (not shown) to be vaporized and vented to the atmosphere to enhance sleeping.

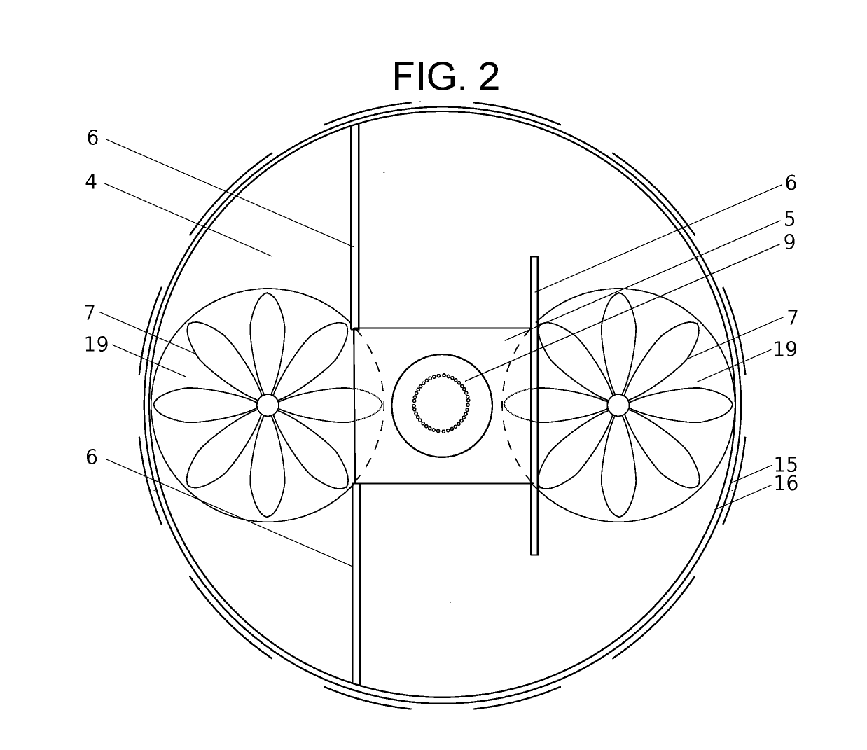

FIG. 2 shows the top view of the multifunctional heater. The two top openings 19 for the fans 7 which are mounted so that the blades are contained within the ventilation holes. The sliding gates for temperature 6 are show with one side open and one side closed. This picture depicts how the air chamber floor 4 which is near the bottom of the device extends to the perimeter of the device. The outer rating vent control 15 and inner rotating vent control 16 are shown form a top view though they are in the middle of the device. The heater module 5 is shown from a top view, and it extends for most of the height of the device. The aromatherapy module 9 sits on top of the heater module 5.

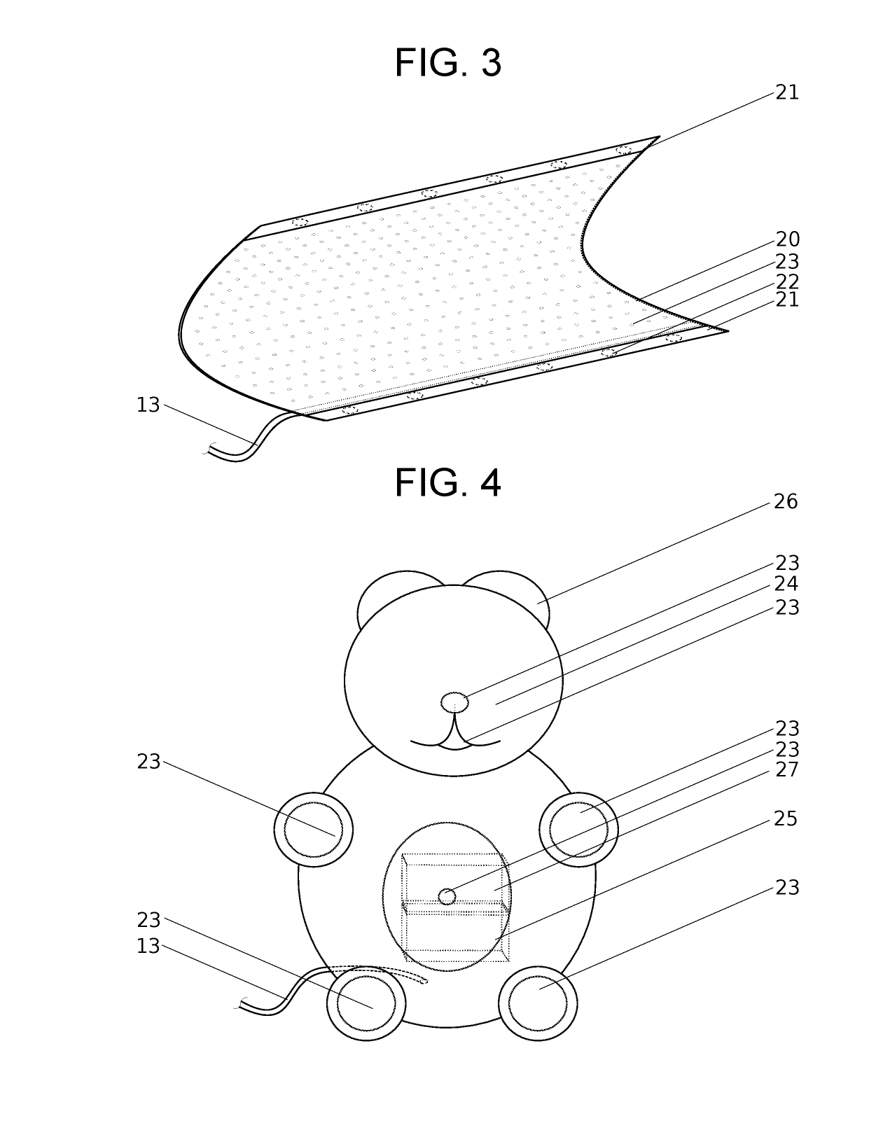

FIG. 3 shows the blanket accessory. The air accessory hose 13 brings in warm air from the multifunctional heater to the blanket which has air holes 23 on the underside to allow the warm air to flow through the blanket to warm the bed. The closing strips, 21 and 22 are on both sides of the blanket and allow the blanket to opened and cleaned as needed.

FIG. 4 shows the stuffed animal warming accessory. The air leaves the stuffed animal 24 through its holes or a mesh in the stuffed animals paws, mouth and nose 23. The stuffed animal accessory has a power source 25 that power the LED lights 26 which are across the tops of the ears. The stuffed animal also contains a Bluetooth or LED module 27 for LED control.

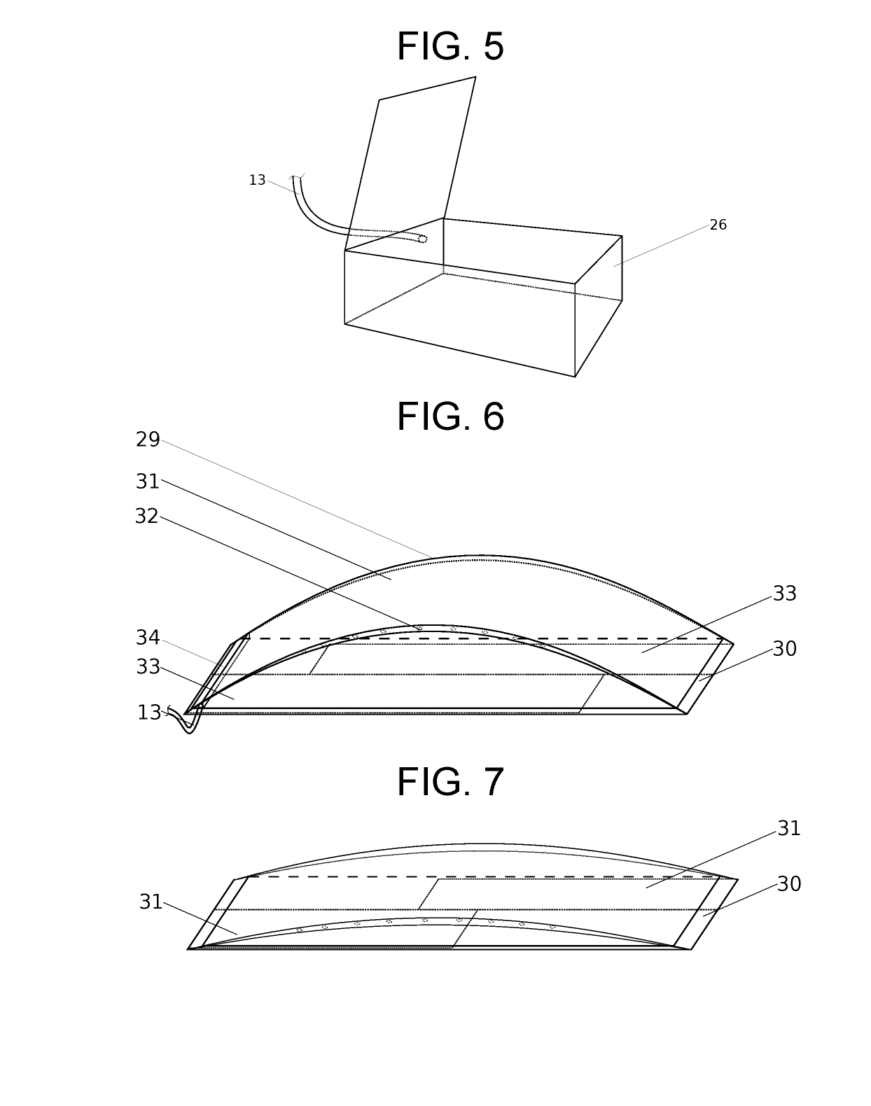

FIG. 5 shows the container for heating towels and clothes 28, Warm air is brought into the box through an accessory hose 13.

FIG. 6 shows the foot warmer accessory. The foot warmer has blanket cover 29 that rises or falls with the air flow into the fabric air chamber 31. Memory foam or other type of pad 30 provides the base to the foot warmer. The fabric air chamber 31 has 360 degree rotatable side vents 32, the air flow through those vents being controlled by sliding slats 33 which control the curvature of the fabric air chamber 31.

FIG. 7 show the foot warmer accessory in a lower position which occurs with lower air flow.

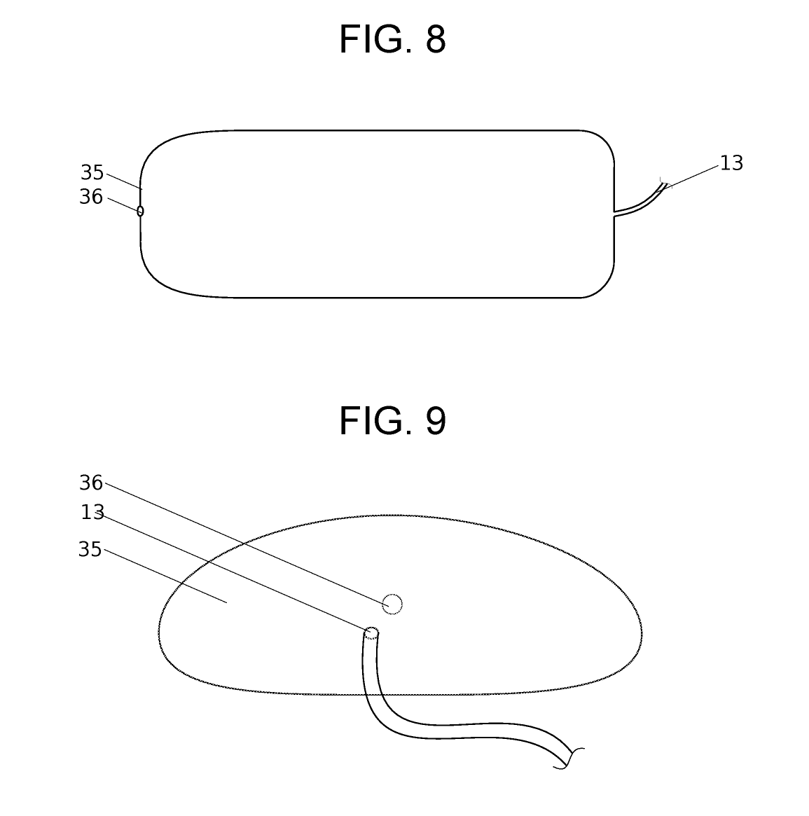

FIG. 8 shows the knee pillow warmer version 35 with the air accessory hose 13 and an air release valve 36.

FIG. 9. Shows the body pillow version 35 with the air accessory hose 13 and an air release valve 36.

FIG. 8 and FIG. 9 are just samples of a wide variety of shapes that could be used to bring warm air to almost any position desired on the bed.

The invention claimed is:

1. A microclimate system with a multifunctional heating casing comprising;
a. the heating element, which could be a resistance heater, a heated fluid, or other heating device;
b. air pumps or fans to move air;
c. a thermostat;
d. a temperature reading device;
e. a mother board controller, which may be controlled remotely either by a cell phone or a remote control;
f. the motherboard also automatically controls the functions of the multifunctional heater controls the functions of the multifunctional heater which include:
regulating the temperature of the air, opening and closing the mechanical parts for the holes;
regulating how much air is being pushed through hoses;
auto-timer on/off;
controls LED lights (decorative or night lights);
allow connections of smart apps;
g. emergency shut on the casing;
h. emergency shut off via cell phone or remote control;
i. timer;
j. display panel;
k. on/off switch;
l. glass element on the top of the casing to hold aromatherapy oils that will vaporized as the heater generates heat;
m. ventilation holes in the housing to bring air outside when the fans are turned on;

2. The device of claim 1 with foot warmer panels that have slats that can move in and out to form an arch and also have the ability to lock in place with vents to allo w the flow of warm cooled air;

3. The device of claim 1, may connecting to separate large universal warming chambers, via hoses and that can warm pillows, knee-wedges, socks, clothing items, towels;

4. The device of claim 1 may connect to body blanket warmer with holes to distribute air throughout the blanket to allows different heating/cooling on two sides of the bed.
